(19) United States
(12) Patent Application Publication
(10) Pub. No.: US 2012/0087411 A1
(43) Pub. Date: Apr. 12, 2012

(54) INTERNAL BIT DEPTH INCREASE IN DEBLOCKING FILTERS AND ORDERED DITHER

(75) Inventor: Barin Geoffry Haskell, Mountain View, CA (US)

(73) Assignee: APPLE INC., Cupertino, CA (US)

(21) Appl. No.: 12/902,906

(22) Filed: Oct. 12, 2010

(51) Int. Cl. H04N 7/34; H04N 7/26

(52) U.S. Cl. 375/240.16; 375/240.24; 375/E07.243; 375/E07.123

(57) ABSTRACT

A dither processing system processes pixel data having an integer component and a fractional component. The system may parse picture data into a plurality of blocks having a size corresponding to a dither matrix. Fractional components of each pixel may be compared to a corresponding dither value from the dither matrix. Based on the comparison, the processing system may determine whether or not to increment the integer components of the respective pixels. By performing such comparisons on a pixel-by-pixel basis, it is expected that this dithering will be more effective than this other dither processing.

### BACKGROUND

The present invention relates to video coding and, more particularly, to video coding system using deblocking filters as part of video coding.

Video codecs typically code video frames using a discrete cosine transform (“DCT”) on blocks of pixels, called “pixel blocks” herein, much the same as used for the original JPEG coder for still images. An initial frame (called an “intra” frame) is coded and transmitted as an independent frame. Subsequent frames, which are modeled as changing slowly due to small motions of objects in the scene, are coded efficiently in the inter mode using a technique called motion compensation (“MC”) in which the displacement of pixel blocks from their position in previously-coded frames are transmitted as motion vectors together with a coded representation of a difference between a predicted pixel block and a pixel block from the source image.

A brief review of motion compensation is provided below. FIGS. 1 and 2 show a block diagram of a motion-compensated image coding system. The system combines transform coding (in the form of the DCT of blocks of pixels) with predictive coding (in the form of differential pulse coded modulation (“PCM”)) in order to reduce storage and computation of the compressed image, and at the same time, to give a high degree of compression and adaptability. Since motion compensation is difficult to perform in the transform domain, the first step in the interframe coder is to create a motion compensated prediction error. This computation requires one or more frame stores in both the encoder and decoder. The resulting error signal is transformed using a DCT, quantized by an adaptive quantizer, entropy encoded using a variable length coder (“VLC”) and buffered for transmission over a channel.

The way that the motion estimator works is illustrated in FIG. 3. In its simplest form, the current frame is partitioned into motion compensation blocks, called “mcblocks” herein, of constant size, e.g., 16×16 or 8×8. However, variable size mcblocks are often used, especially in newer codecs such as H.264. ITU-T Recommendation H.264, Advanced Video Coding. Indeed nonrectangular mcblocks have also been studied and proposed. Mcblocks are generally larger than or equal to pixel blocks in size.

Again, in the simplest form of motion compensation, the previous decoded frame is used as the reference frame, as shown in FIG. 3. However, one of many possible reference frames may also be used, especially in newer codecs such as H.264. In fact, with appropriate signaling, a different reference frame may be used for each mcblock.

Each mcblock in the current frame is compared with a set of displaced mcblocks in the reference frame to determine which one best predicts the current mcblock. When the best matching mcblock is found, a motion vector is determined that specifies the displacement of the reference mcblock.

Exploiting Spatial Redundancy

Because video is a sequence of still images, it is possible to achieve some compression using techniques similar to JPEG. Such methods of compression are called intraframe coding techniques, where each frame of video is individually and independently compressed or encoded. Intraframe coding exploits the spatial redundancy that exists between adjacent pixels of a frame. Frames coded using only intraframe coding are called “I-frames”.

Exploiting Temporal Redundancy

In the unidirectional motion estimation described above, called “forward prediction”, a target mcblock in the frame to be encoded is matched with a set of mcblocks of the same size in a past frame called the “reference frame”. The mcblock in the reference frame that “best matches” the target mcblock is used as the reference mcblock. The prediction error is then computed as the difference between the target mcblock and the reference mcblock. Prediction mcblocks do not, in general, align with coded mcblock boundaries in the reference frame. The position of this best-matching reference mcblock is indicated by a motion vector that describes the displacement between it and the target mcblock. The motion vector information is also encoded and transmitted along with the prediction error. Frames coded using forward prediction are called “P-frames”.

The prediction error itself is transmitted using the DCT-based intraframe encoding technique summarized above.

Bidirectional Temporal Prediction

Bidirectional temporal prediction, also called “motion-compensated interpolation”, is a key feature of modern video codecs. Frames coded with bidirectional prediction use two reference frames, typically one in the past and one in the future. However, two of many possible reference frames may also be used, especially in newer codecs such as H.264. In fact, with appropriate signaling, different reference frames may be used for each mcblock.

A target mcblock in bidirectionally-coded frames can be predicted by a mcblock from the past reference frame (forward prediction), or one from the future reference frame (backward prediction), or by an average of two mcblocks, one from each reference frame (interpolation). In every case, a prediction mcblock from a reference frame is associated with a motion vector, so that up to two motion vectors per mcblock may be used with bidirectional prediction. Motion-compensated interpolation for a mcblock in a bidirectionally-predicted frame is illustrated in FIG. 4. Frames coded using bidirectional prediction are called “B-frames”.

Bidirectional prediction provides a number of advantages. The primary one is that the compression obtained is typically higher than can be obtained from forward (unidirectional) prediction alone. To obtain the same picture quality, bidirectionally-predicted frames can be encoded with fewer bits than frames using only forward prediction.

However, bidirectional prediction does introduce extra delay in the encoding process, because frames must be encoded out of sequence. Further, it entails extra encoding complexity because mcblock matching (the most computationally intensive encoding procedure) has to be performed twice for each target mcblock, once with the past reference frame and once with the future reference frame.

Typical Encoder Architecture for Bidirectional Prediction

FIG. 5 shows a typical bidirectional video encoder. It is assumed that frame reordering takes place before coding, i.e., I- or P-frames used for B-frame prediction must be coded and transmitted before any of the corresponding B-frames. In this codec, B-frames are not used as reference frames. With a change of architecture, they could be as in H.264.

Input video is fed to a Motion Compensation Estimator/Predictor that feeds a prediction to the minus input of the subtractor. For each mcblock, the Inter/Intra Classifier then compares the input pixels with the prediction error output of the subtractor. Typically, if the mean square prediction error exceeds the mean square pixel value, an intra mcblock is decided. More complicated comparisons involving DCT of both the pixels and the prediction error yield somewhat better performance, but are not usually deemed worth the cost.

For intra mcblocks, the prediction is set to zero. Otherwise, it comes from the Predictor, as described above. The prediction error is then passed through the DCT and quantizer before being coded, multiplexed and sent to the Buffer.

Quantized levels are converted to reconstructed DCT coefficients by the Inverse Quantizer and then the inverse is transformed by the inverse DCT unit (“IDCT”) to produce a coded prediction error. The Adder adds the prediction to the prediction error and clips the result, e.g., to the range 0 to 255, to produce coded pixel values.

For B-frames, the Motion Compensation Estimator/Predictor uses both the previous frame and the future frame kept in picture stores.

For I- and P-frames, the coded pixels output by the Adder are written to the Next Picture Store, while at the same time the old pixels are copied from the Next Picture store to the Previous Picture store. In practice, this is usually accomplished by a simple change of memory addresses.

Also, in practice the coded pixels may be filtered by an adaptive deblocking filter prior to entering the picture store. This improves the motion compensation prediction, especially for low bit rates where coding artifacts may become visible.

The Coding Statistics Processor in conjunction with the Quantizer Adapter controls the output bit rate and optimizes the picture quality as much as possible.

Typical Decoder Architecture for Bidirectional Prediction

FIG. 6 shows a typical bidirectional video decoder. It has a structure corresponding to the pixel reconstruction portion of the encoder using inverting processes. It is assumed that frame reordering takes place after decoding and video output. The deblocking filter might be placed at the input to the picture stores as in the encoder, or it may be placed at the output of the Adder in order to reduce visible artifacts in the video output.

Fractional Motion Vector Displacements

FIG. 3 and FIG. 4 show reference mcblocks in reference frames as being displaced vertically and horizontally with respect to the position of the current mcblock being decoded in the current frame. The amount of the displacement is represented by a two-dimensional vector [dx, dy], called the motion vector. Motion vectors may be coded and transmitted, or they may be estimated from information already in the decoder, in which case they are not transmitted. For bidirectional prediction, each transmitted mcblock requires two motion vectors.

In its simplest form, dx and dy are signed integers representing the number of pixels horizontally and the number of lines vertically to displace the reference mcblock. In this case, reference mcblocks are obtained merely by reading the appropriate pixels from the reference stores.

However, in newer video codecs it has been found beneficial to allow fractional values for dx and dy. Typically, they allow displacement accuracy down to a quarter pixel, i.e., an integer +−0.25, 0.5 or 0.75.

Fractional motion vectors require more than simply reading pixels from reference stores. In order to obtain reference mcblock values for locations between the reference store pixels, it is necessary to interpolate between them.

Simple bilinear interpolation can work fairly well. However, in practice it has been found beneficial to use two-dimensional interpolation filters especially designed for this purpose. In fact, for reasons of performance and practicality, the filters are often not shift-invariant filters. Instead different values of fractional motion vectors may utilize different interpolation filters.

Deblocking Filter

A deblocking filter performs filtering that smoothes discontinuities at the edges of the pixel blocks due to quantization of transform coefficients. These discontinuities often are visible at low coding rates. It may occur inside the decoding loop of both the encoder and decoder, and/or it may occur as a post-processing operation at the output of the decoder. Luma and chroma values may be deblocked independently or jointly.

In H.264, deblocking is a highly nonlinear and shift-variant pixel processing operation that occurs within the decoding loop. Because it occurs within the decoding loop, it must be standardized.

Motion Compensation Using Adaptive Deblocking Filters

The optimum deblocking filter depends on a number of factors. For example, objects in a scene may not be moving in pure translation. There may be object rotation, both in two dimensions and three dimensions. Other factors include zooming, camera motion and lighting variations caused by shadows, or varying illumination.

Camera characteristics may vary due to special properties of their sensors. For example, many consumer cameras are intrinsically interlaced, and their output may be de-interlaced and filtered to provide pleasing-looking pictures free of interlacing artifacts. Low light conditions may cause an increased exposure time per frame, leading to motion dependent blur of moving objects. Pixels may be non-square. Edges in the picture may make directional filters beneficial.

Thus, in many cases improved performance can be had if the deblocking filter can adapt to these and other outside factors. In such systems, deblocking filters may be designed by minimizing the mean square error between the current uncoded mcblocks and deblocked coded mcblocks over each frame. These are the so-called Wiener filters. The filter coefficients would then be quantized and transmitted at the beginning of each frame to be used in the actual motion compensated coding.

The deblocking filter may be thought of as a motion compensation interpolation filter for integer motion vectors. Indeed if the deblocking filter is placed in front of the motion compensation interpolation filter instead of in front of the reference picture stores, the pixel processing is the same. However, the number of operations required may be increased, especially for motion estimation.

Internal Bit Depth Increasing (“IBDI”) Deblocking Filters and Dither

During the processing involved in deblocking filters, and video filters in general, rounding operations can cause visible blockiness and false contours, especially in darker areas of a picture. The visibility of such artifacts is highly dependent on such factors as ambient lighting, gamma correction, display characteristics, etc. In order to mask these artifacts, dither in the form of random noise often is added to the pixels. The effect is to reduce the visibility of false contours at the expense of increased visible noise. The result is deemed by most subjects to be an improvement in overall perceived picture quality.

Sometimes the random noise is added only to the least significant bit of each pixel.

In other implementations, the internal pixel value is represented by an integer part I plus a fractional part f, where the bit depth of I is determined by the desired output bit depth, and 0≦f<1. Then the dither noise is added only to the fractional part f just before the rounding operation. The dither noise may be clipped to not exceed 0.5 in value.

Ordered Dither

It has been determined in graphics applications that a technique called Ordered Dither often provides improved performance compared with random noise dither. In many cases, Ordered Dither can actually give the perception of increased bit depth over and above that of the real output bit depth. No known coding application, however, has proposed use of Ordered Dither for application within the motion compensation prediction loop where decoded reference pictures are stored for use in prediction of subsequently-processed frames. All applications of ordered dither, so far as presently known, have been limited to rendering operations where a final image is deblocked immediately prior to display.

### BRIEF DESCRIPTION OF THE DRAWINGS

FIG. 1 is a block diagram of a conventional video coder.

FIG. 2 is a block diagram of a conventional video decoder.

FIG. 3 illustrates principles of motion compensated prediction.

FIG. 4 illustrates principles of bidirectional temporal prediction.

FIG. 5 is a block diagram of a conventional bidirectional video coder.

FIG. 6 is a block diagram of a conventional bidirectional video decoder.

FIG. 7 illustrates an encoder/decoder system suitable for use with embodiments of the present invention.

FIG. 8 is a simplified block diagram of a video encoder according to an embodiment of the present invention.

FIG. 9 is a simplified block diagram of a video decoder according to an embodiment of the present invention.

FIG. 10 illustrates a method according to an embodiment of the present invention.

FIG. 11 illustrates another method according to an embodiment of the present invention.

FIGS. 12-14 illustrate exemplary dither matrices according to various embodiments of the present invention and their effect on dither processing.

FIG. 15 illustrates a further method according to an embodiment of the present invention.

FIG. 16 illustrates another method according to an embodiment of the present invention.

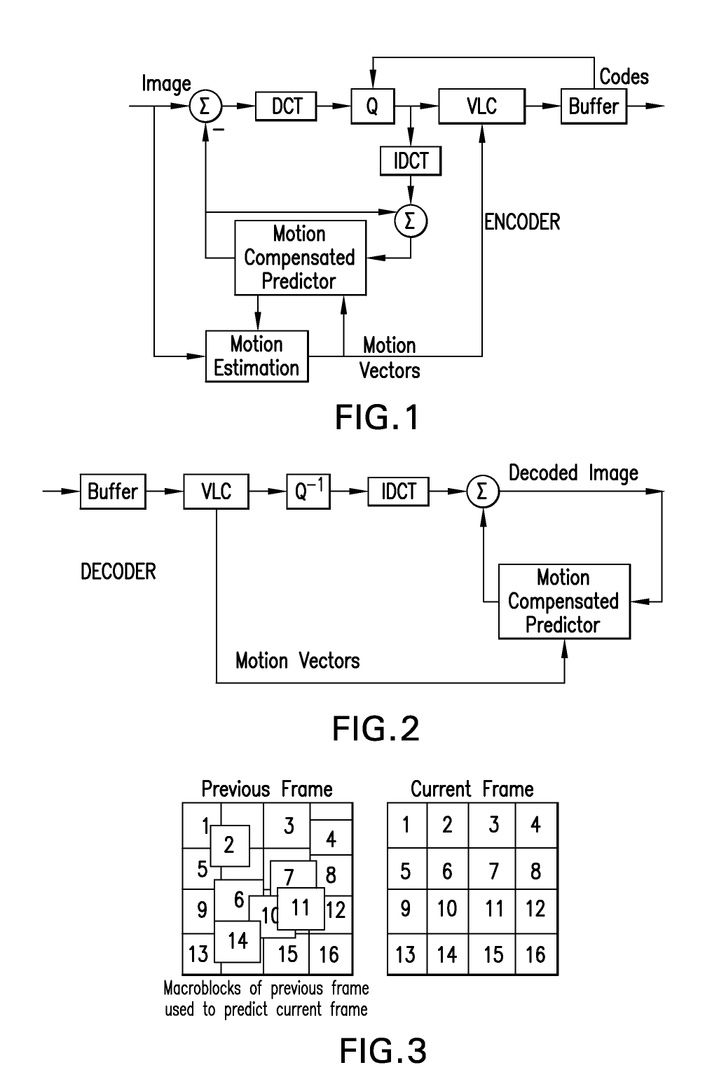

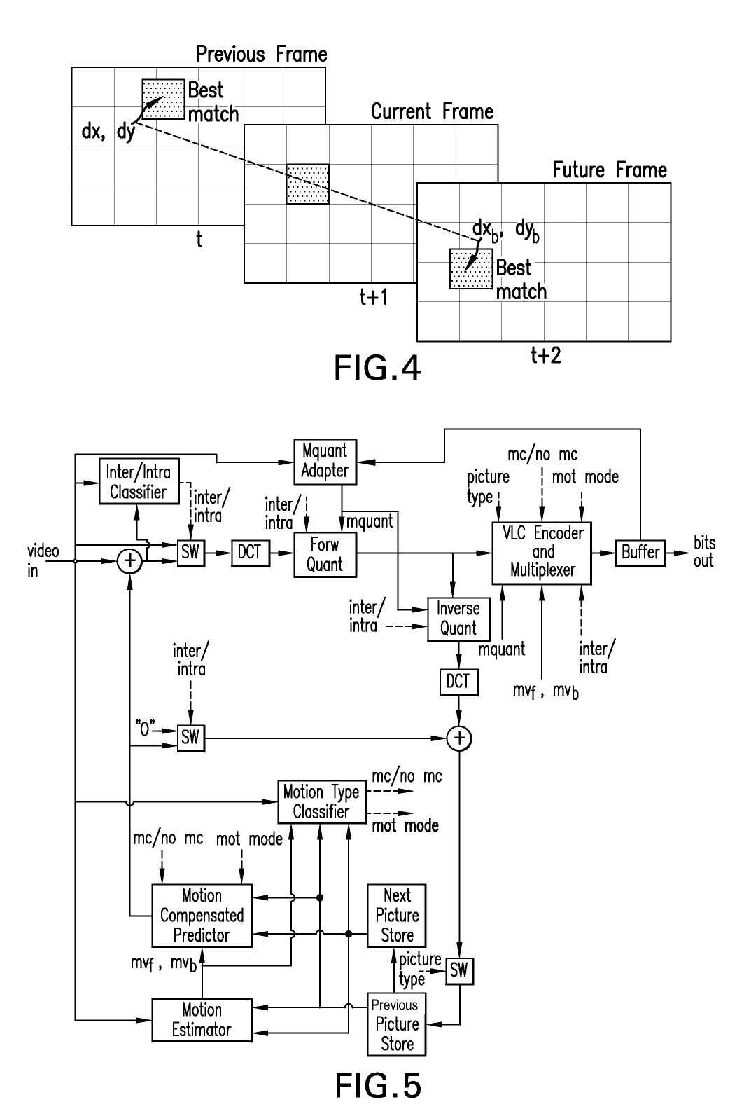

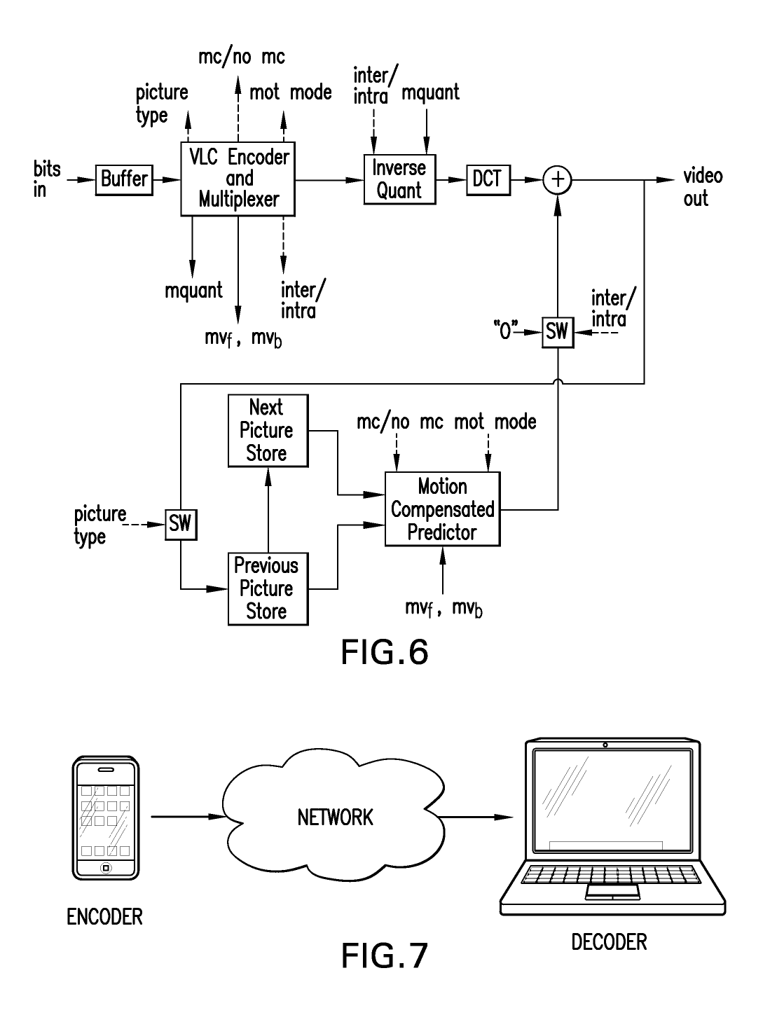

### DETAILED DESCRIPTION

Embodiments of the present invention provide a dither processing system for pixel data having an integer component and a fractional component. According to these embodiments, picture data may be parsed into a plurality of blocks having a size corresponding to a dither matrix. Fractional components of each pixel may be supplemented with a corresponding dither value from the dither matrix. Through such supplementation, the processing system may determine whether or not to increment the integer components of the respective pixels. By performing such comparisons on a pixel-by-pixel basis, it is expected that this dithering will be effective for deblocking operations performed within a prediction loop.

FIG. 7 illustrates a coder/decoder system suitable for use with the present invention. There, an encoder 110 is provided in communication with a decoder 120 via a network 130. The encoder 110 may perform coding operations on a data stream of source video which may be captured locally at the encoder via a camera device or retrieved from a storage device (not shown). The coding operations reduce the bandwidth of the source video data, generating coded video therefrom. The encoder 110 may transmit the coded video to the decoder 120 over the network 130. The decoder 120 may invert coding operations performed by the encoder 110 to generate a recovered video data stream from the coded video data. Coding operations performed by the encoder 110 typically are lossy processes and, therefore, the recovered video data may be an inexact replica of the source video data. The decoder 120 may render the recovered video data on a display device or it may store the recovered video data for later use.

As illustrated, the network 130 may transfer coded video data from the encoder 110 to the decoder 120. The network 130 may be provided as any number of wired or wireless communications networks, computer networks or a combination thereof. Further, the network 130 may be provided as a storage unit, such as an electrical, optical or magnetic storage device.

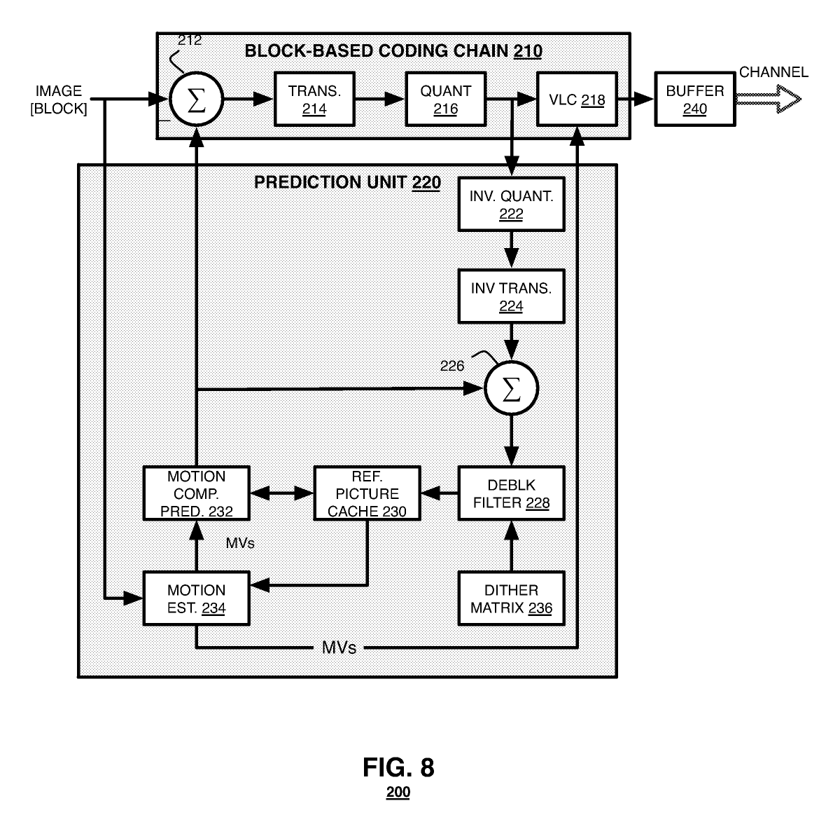

FIG. 8 is a simplified block diagram of an encoder suitable for use with the present invention. The encoder 200 may include a block-based coding chain 210 and a prediction unit 220.

The block-based coding chain 210 may include a subtractor 212, a transform unit 214, a quantizer 216 and a variable length coder 218. The subtractor 212 may receive an input mcblock from a source image and a predicted mcblock from the prediction unit 220. It may subtract the predicted mcblock from the input mcblock, generating a block of pixel residuals. The transform unit 214 may convert the mcblock's residual data to an array of transform coefficients according to a spatial transform, typically a discrete cosine transform (“DCT”) or a wavelet transform. The quantizer 216 may truncate transform coefficients of each block according to a quantization parameter (“QP”). The QP values used for truncation may be transmitted to a decoder in a channel. The variable length coder 218 may code the quantized coefficients according to an entropy coding algorithm, for example, a variable length coding algorithm. Following variable length coding, the coded data of each mcblock may be stored in a buffer 240 to await transmission to a decoder via a channel.

The prediction unit 220 may include: an inverse quantization unit 222, an inverse transform unit 224, an adder 226, a deblocking filter 228, a reference picture cache 230, a motion compensated predictor 232, a motion estimator 234 and a dither matrix 236. The inverse quantization unit 222 may quantize coded video data according to the QP used by the quantizer 216. The inverse transform unit 224 may transform re-quantized coefficients to the pixel domain. The adder 226 may add pixel residuals output from the inverse transform unit 224 with predicted motion data from the motion compensated predictor 232. The deblocking filter 228 may filter recovered image data at seams between the recovered mcblock and other recovered mcblocks of the same frame. As part of its operations, it may perform IBDI operations with reference to a dither matrix 236. The reference picture cache 230 may store recovered frames for use as reference frames during coding of later-received mcblocks.

The motion compensated predictor 232 may generate a predicted mcblock for use by the block coder. In this regard, the motion compensated predictor may retrieve stored mcblock data of the selected reference frames, and select an interpolation mode to be used and apply pixel interpolation according to the selected mode. The motion estimator 234 may estimate image motion between a source image being coded and reference frame(s) stored in the reference picture cache. It may select a prediction mode to be used (for example, unidirectional P-coding or bidirectional B-coding), and generate motion vectors for use in such predictive coding.

During coding operations, motion vectors, quantization parameters and other coding parameters may be output to a channel along with coded mcblock data for decoding by a decoder (not shown).

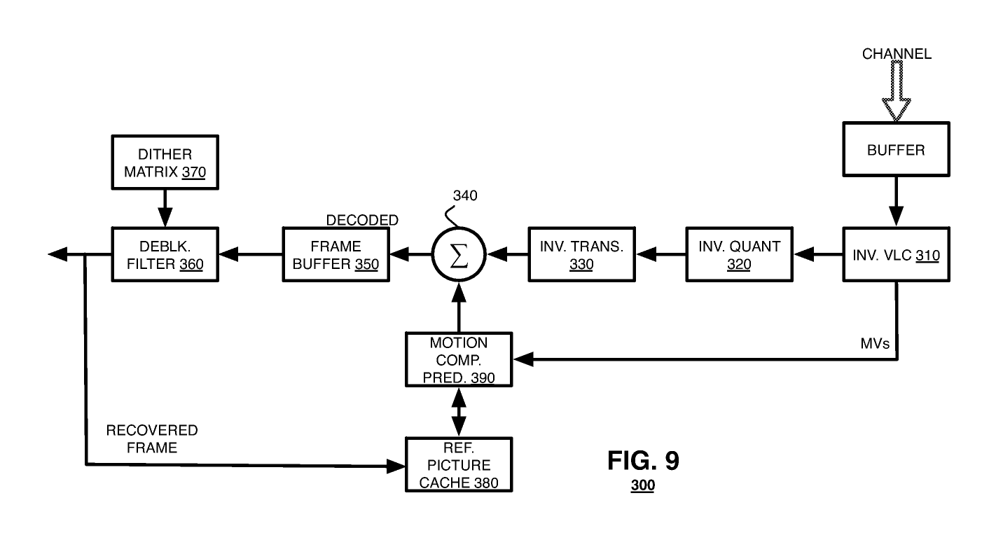

FIG. 9 is a simplified block diagram of a decoder 300 according to an embodiment of the present invention. The decoder 300 may include a variable length decoder 310, an inverse quantizer 320, an inverse transform unit 330, an adder 340, a frame buffer 350, a deblocking filter 360 and dither matrix 370. The decoder 300 further may include a prediction unit that includes a reference picture cache 380 and a motion compensated predictor 390.

The variable length decoder 310 may decode data received from a channel buffer. The variable length decoder 310 may route coded coefficient data to an inverse quantizer 320, motion vectors to the motion compensated predictor 390 and deblocking filter index data to the dither matrix 370. The inverse quantizer 320 may multiply coefficient data received from the inverse variable length decoder 310 by a quantization parameter. The inverse transform unit 330 may transform dequantized coefficient data received from the inverse quantizer 320 to pixel data. The inverse transform unit 330, as its name implies, performs the converse of transform operations performed by the transform unit of an encoder (e.g., DCT or wavelet transforms). The adder 340 may add, on a pixel-by-pixel basis, pixel residual data obtained by the inverse transform unit 330 with predicted pixel data obtained from the motion compensated predictor 390. The adder 340 may output recovered mcblock data, from which a recovered frame may be constructed and rendered a display device (not shown). The frame buffer 350 may accumulate decoded mcblocks and build reconstructed frames therefrom. As part of its operations, it may perform IBDI operations with reference to a dither matrix 370. The reference picture cache 380 may store recovered frames for use as reference frames during coding of later-received mcblocks.

Motion compensated prediction may occur via the reference picture cache 380 and a motion compensated predictor 390. The reference picture cache 380 may store recovered image data output by the deblocking filter 360 for frames identified as reference frames (e.g., decoded I- or P-frames). The motion compensated predictor 390 may retrieve reference mcblock(s) from the reference picture cache 380, responsive to mcblock motion vector data received from the channel. The motion compensated predictor may output the reference mcblock to the adder 340.

In another embodiment, the output of the frame buffer 350 may be input to the reference picture cache 380. In this embodiment, operations of the deblocking filter may be applied to recovered video output by the frame but they would not be stored in the reference picture cache 380 for use in prediction of subsequently received coded video. Such an embodiment allows the decoder 300 to be used with encoders (not shown) that do not perform similar bit depth enhancement operations within their coding loops and still provide improved output data.

According to an embodiment of the present invention, the encoder 200 (FIG. 8) and decoder 300 (FIG. 9) each may include deblocking filters that apply ordered dither to decoded reference frames prior to storage in their respective reference picture caches 230, 380. The reference pictures obtained thereby are expected to have greater perceived image quality than frames without such dither and, by extension, should lead to better perceived image quality when the reference frames serve as prediction references for other frames.

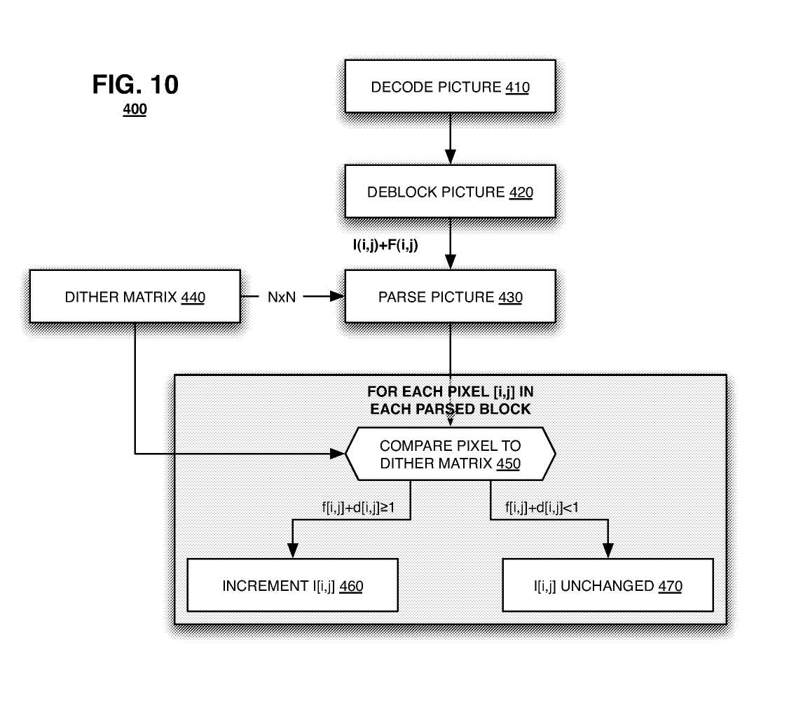

FIG. 10 illustrates a method 400 for applying dither to video data according to an embodiment of the present invention. According to the method, a coded picture may be decoded (box 410) and deblocked (box 420) to generate recovered pixel data that has been filtered. After application of the deblocking, each pixel location (i,j) within the picture may be represented as an integer component (labeled “I(i,j)”) corresponding to the bit depth of the system and a fractional component (labeled “F(i,j)”). In many implementations, pixel data may be represented as multiple color components; in such a case, each color component may be represented as integer and fractional components respectively (e.g., I_{R}(i,j)+F_{R}(i,j), I_{G}(i,j)+F_{G}(i,j), I_{B}(i,j)+F_{B}(i,j), for red, green and blue components). Although the following discussion describes operations performed with respect to a single-component pixel value, the principles of the present discussion may be extended to as many component values as are used to represent pixel content.

At box 430, the method 400 may parse the picture into N×N blocks, according to a size of a dither matrix (box 440) at work in the system. The parsed blocks may but need not coincide with mcblocks used by the coding/decoding processes, such as those represented by box 410. Within each parsed block, the method 400 may compute a sum of the fractional component of each pixel value F(i,j) and a co-located value in the dither matrix (labeled “D(i,j)”). The method 400 may decide to round up the integer component of the pixel I(i,j) based on the computation. For example, as shown in FIG. 10, the method may increment I(i,j) if the sum is equal to or exceeds 1 (box 460) but may leave it unchanged if not (box 470).

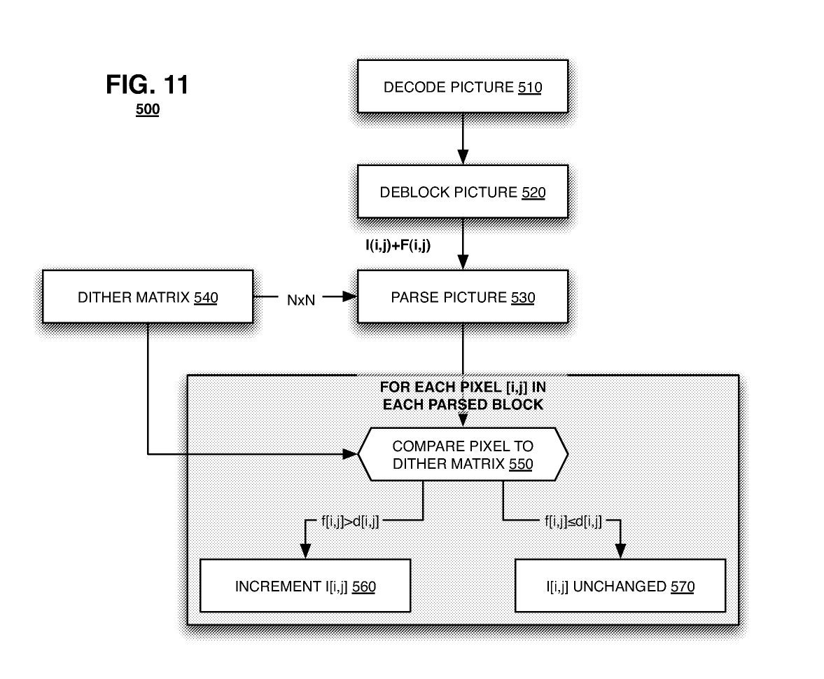

FIG. 11 illustrates another method 500 for applying dither to video data according to an embodiment of the present invention. According to the method, a coded picture may be decoded (box 510) and deblocked (box 520) to generate recovered pixel data that has been filtered. Again, after application of the deblocking, each pixel location (i,j) within the picture may be represented as an integer component (I(i,j)) corresponding to the bit depth of the system and a fractional component (F(i,j)). Further, although the following discussion describes operations performed with respect to a single-component pixel value, the principles of the present discussion may be extended to as many component values (red, green, blue) as are used to represent pixel content.

At box 530, the method 500 may parse the picture into N×N blocks, according to a size of a dither matrix (box 540) at work in the system. The parsed blocks may but need not coincide with mcblocks used by the coding/decoding processes, such as those represented by box 510. Within each parsed block, the method 500 may compare the fractional component of each pixel value F(i,j) to a co-located value in the dither matrix (labeled “D(i,j)”). The method 500 may decide to round up the integer component of the pixel I(i,j) based on the comparison. For example, as shown in FIG. 10, the method may increment I(i,j) if the fractional component exceeds the dither value (F(i,j)>D(i,j)) (box 560) but may leave it unchanged if not (box 570).

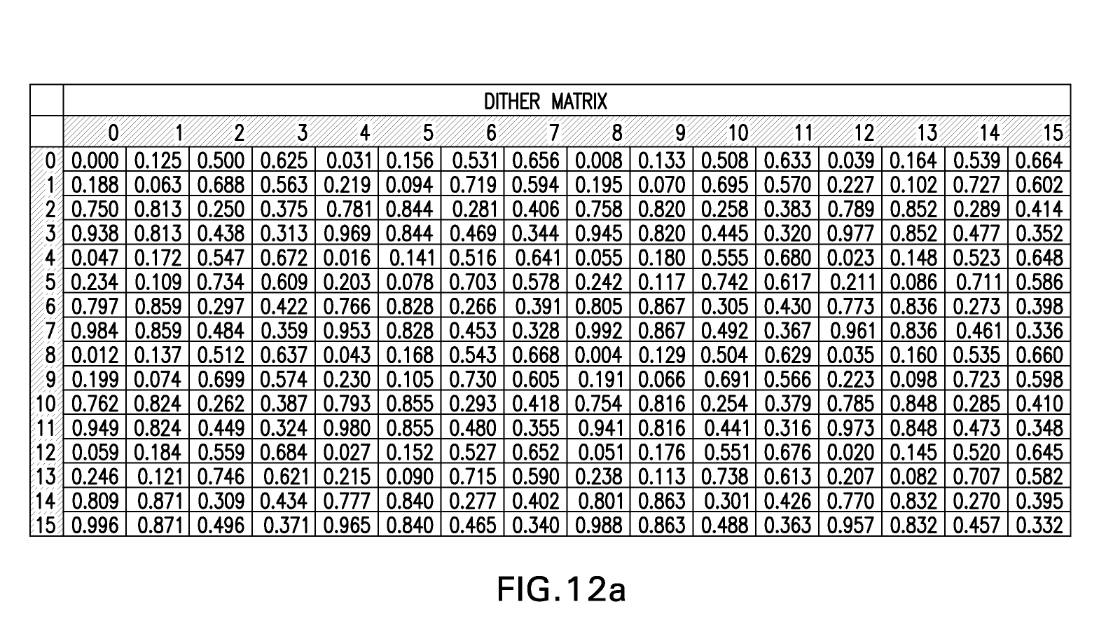

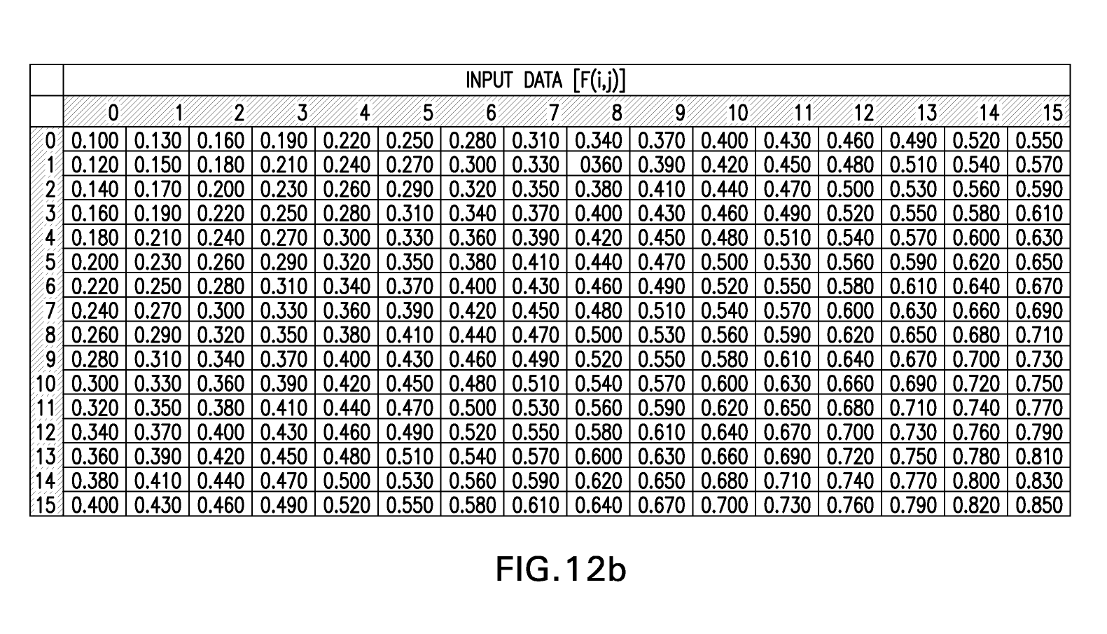

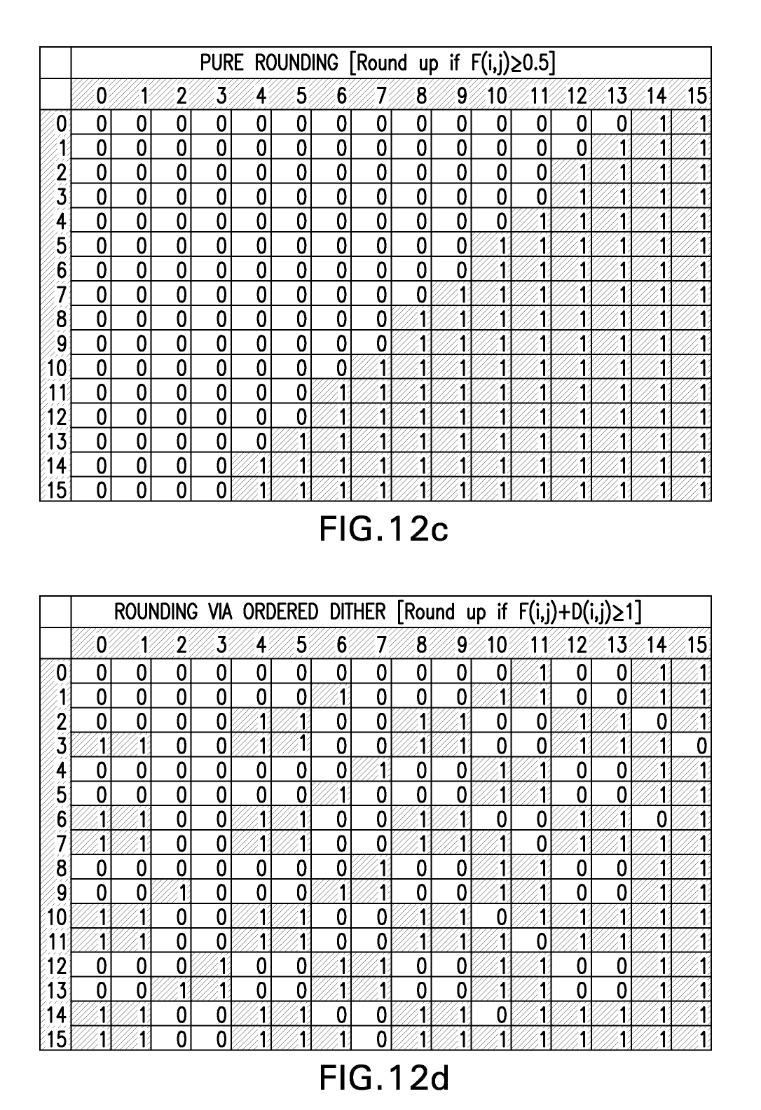

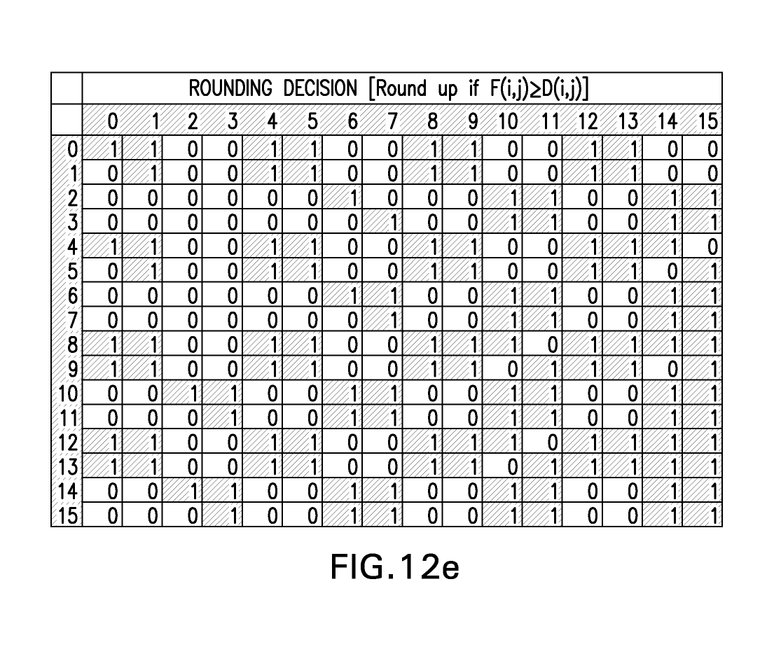

FIG. 12 illustrates operation of the methods of FIGS. 10 and 11 in the context of an exemplary set of input data and a dither matrix. FIG. 12(a) illustrates values of an exemplary 16×16 dither matrix. In this example, each cell (i,j) has a fractional value of the form (X−1)/N², where N represents the size of the dither matrix (N=16 in FIG. 12) and X is an integer having a value between 1 and N². The values shown in FIG. 12(a) do not repeat within the dither matrix (e.g., d(i1,j1)≠d(i2,j2) for all combinations of i1,j1 and i2,j2).

FIG. 12(b) illustrates an exemplary block of fractional values that might be obtained after parsing. For the purposes of the present discussion, assume that all pixels in the block have a common integer component after filtering (e.g., I(i1,j1)=I(i2,j2) for all combinations of i1,j1 and i2,j2 within the block). Values in the example of FIG. 12(b) have been selected to illustrate operative principles of the method of FIGS. 10 and 11. For example, if pure rounding were applied to the block of FIG. 12(b), it would lead to a visual pattern as shown in FIG. 12(c), which may be perceived as a discrete boundary between two different image areas. Ideally, the block would be perceived as a smooth image without such a boundary.

FIG. 12(d) illustrates decisions that would be reached using the method of FIG. 10, for example, where I(i,j) is incremented if F(i,j)+D(i,j)≧1. FIG. 12(e) illustrates decisions that would be reached using the technique of FIG. 11, where I(i,j) is incremented if F(i,j)≧D(i,j). As shown, ordered dither can randomize pattern artifacts to a greater degree than under the FIG. 12(b) case.

In each of foregoing example, cells of FIGS. 12(c)-(e) are shown as having values “0” or “1” to illustrate when the integer component I(i,j) is to be incremented or not.

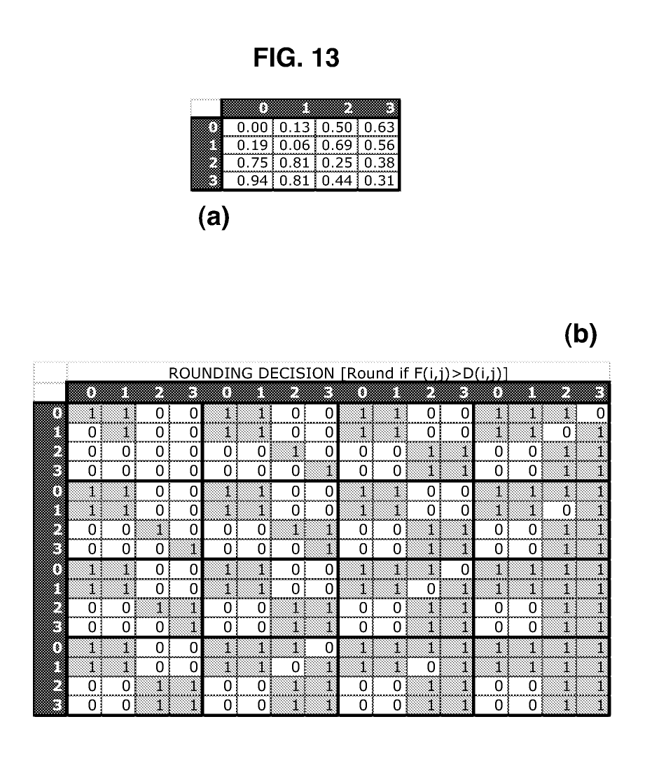

Although the foregoing example describes operation of the method in the context of a 16×16 dither matrix, the principles of the present invention may be employed with dither matrices of arbitrary size. FIG. 13(a), for example, illustrates an exemplary 4×4 dither matrix and decisions that may be reached by application of the method of FIG. 11 to the input data of FIG. 12(b). In this example, the input data would be parsed into multiple 4×4 blocks. Pixels within each of the 4×4 blocks would be compared to values of the dither matrix, the method of FIG. 10 also can be used with dither matrices of arbitrary size.

The ordered dither matrices of the foregoing examples were obtained by from a recursive relationship as follows:

$${D}^{N} = [ \begin{matrix}4 {D}^{N / 2} + {D}^{2} ( 0 , 0 ) {U}^{N / 2} & 4 {D}^{N / 2} + {D}^{2} ( 1 , 0 ) {U}^{N / 2} \\ 4 {D}^{N / 2} + {D}^{2} ( 0 , 1 ) {U}^{N / 2} & 4 {D}^{N / 2} + {D}^{2} ( 1 , 1 ) {U}^{N / 2}\end{matrix} ] ,$$

where N represents the size of the D matrix,

$${D}^{2} = [ \begin{matrix}0 & 2 \\ 3 & 1\end{matrix} ] and {U}^{N} = [ \begin{matrix}1 & 1 & … & 1 \\ 1 & 1 & & 1 \\ ⋮ & & ⋱ & ⋮ \\ 1 & 1 & … & 1\end{matrix} ] .$$

Values of the matrix D^{N} may be scaled by a factor 1/N² to generate final values for the ordered dither matrix.

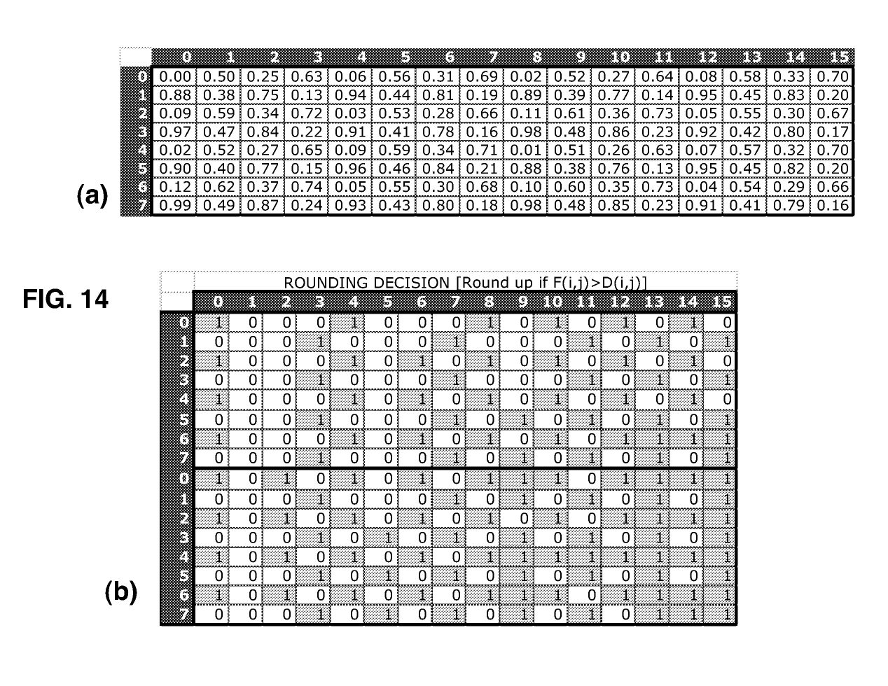

FIG. 14(a) illustrates an exemplary 8×16 dither matrix and decisions that may be reached by application of the method of FIG. 11 to the input data of FIG. 12(b). In this embodiment, values of the dither matrix have the form (X−1)/(H×W), where H represents the height of the dither matrix, W represents its width and X is a random integer having a value between 1 and H×W.

Further, the dither matrices need not be of uniform size when applied to a single frame. Optionally, for example, encoders and decoders may use a 16×16 dither matrix, a 4×4 matrix and an 8×16 matrix across different regions of a frame as part of their deblocking operations.

Other embodiments accommodate a variation in the types of comparisons made under the method. For example, the method of FIG. 10 may increment I(i,j) (box 460) if the sum is less than 1 but leave it unchanged (box 470) otherwise. Similarly, the method of FIG. 11 may increment I(i,j) (box 560) if the fractional component is less than the dither value but leave it unchanged (box 570) otherwise. Further, orientation of the dither matrix may be variation to achieve further dither in operation (e.g., compare F(i,j) to D(H-i, W-j) for select blocks).

In another embodiment, dither processing may be performed selectively for adaptively identified sub-regions of the picture. For other sub-regions of a pixel, simple rounding or truncation is used. For example, blockiness and false contouring tend to be highly visible for relatively dark areas of a picture but less visible for high luminance areas of the picture. In such an embodiment, the method may estimate the luminance of each region of the picture (for example, pixel blocks identified by the parsing) and may apply dithering only if the average luminance in a region is less than some threshold value.

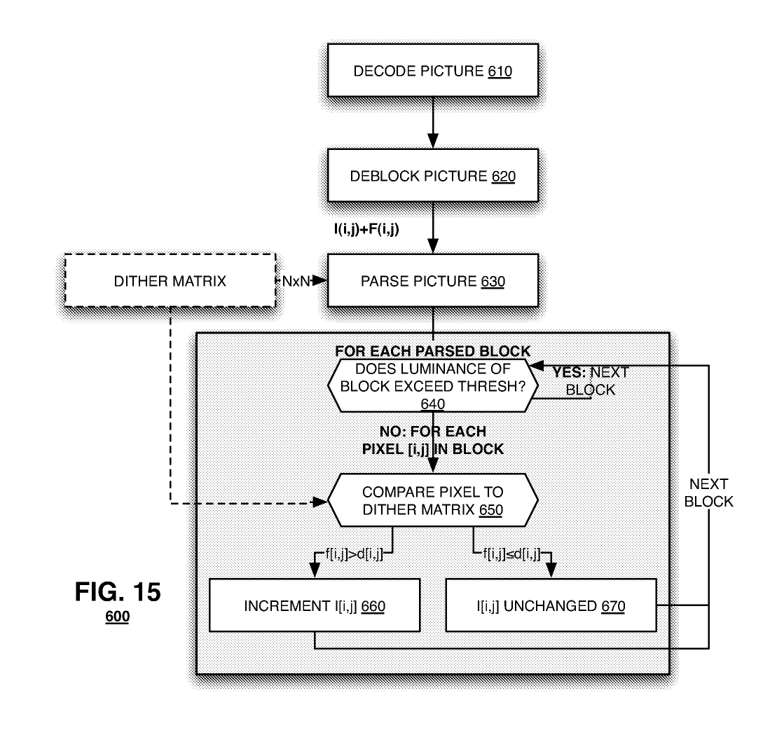

FIG. 15 illustrates a method 600 for applying dither to video data according to another embodiment of the present invention. According to the method, a coded picture may be decoded (box 610) and deblocked (box 620) to generate recovered pixel data that has been filtered. After application of the deblocking, each pixel location (i,j) within the picture may be represented by an integer component and a fractional component (I(i,j)+F(i,j)). In many implementations, pixel data may be represented as multiple color components; in such a case, each color component may be represented as integer and fractional components respectively (e.g., I_{R}(i,j)+F_{R}(i,j), I_{G}(i,j)+F_{G}(i,j), I_{B}(i,j)+F_{B}(i,j), for red, green and blue components).

At box 630, the method 600 may parse the picture into blocks of a predetermined size (e.g., N×N or H×W), according to a size of a dither matrix at work in the system. The parsed blocks may but need not coincide with mcblocks used by the coding/decoding processes, such as those represented by box 610. Within each parsed block, the method 600 may compare the luminance of the block to a predetermined threshold (box 640). The block's luminance may be obtained, for example, by averaging luma values for the pixels within the block. If the block luminance exceeds the threshold, the method may advance to the next block without applying dither. If not, then the method may apply dithering as described above with respect to FIG. 10 or 11. The example of FIG. 15 illustrates the method comparing the fractional component of each pixel value F(i,j) to a co-located value in the dither matrix (D(i,j)) (box 650) and incrementing the integer component of the pixel I(i,j) selectively based on the comparison (boxes 660, 670). Alternatively, the computational basis of FIG. 10 may be used.

As compared to the embodiment of FIG. 10, the embodiment of FIG. 15 avoids injection of dither noise into high luminance regions of a picture.

In another example, dither processing may be performed selectively for adaptively identified sub-regions of the picture based on picture complexity. Otherwise, simple rounding or truncation is used. Blockiness and false contouring tend to be highly visible for smooth areas of a picture but less visible in areas of a picture that have higher levels of detail. In such an embodiment, the method may estimate the complexity of each region of the picture (for example, pixel blocks identified by the parsing) and may apply dithering only if the complexity is less than some threshold value.

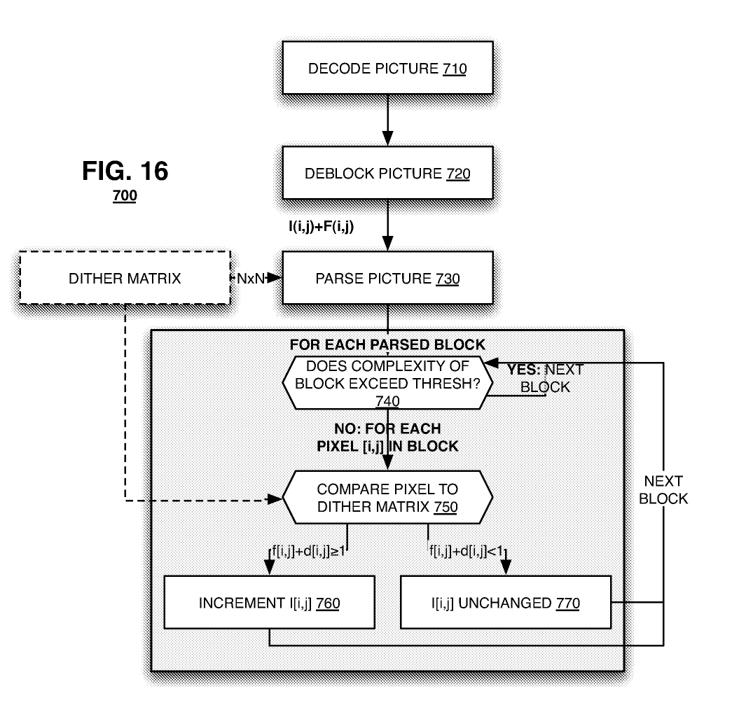

FIG. 16 illustrates a method 700 for applying dither to video data according to another embodiment of the present invention. According to the method, a coded picture may be decoded (box 710) and deblocked (box 720) to generate recovered pixel data that has been filtered. After application of the deblocking, each pixel location (i,j) within the picture may be represented by an integer component and a fractional component (I(i,j)+F(i,j)). In many implementations, pixel data may be represented as multiple color components; in such a case, each color component may be represented as integer and fractional components respectively (e.g., IR(i,j)+FR(i,j), IG(i,j)+FG(i,j), IB(i,j)+FB(i,j), for red, green and blue components).

At box 730, the method 700 may parse the picture into blocks of a predetermined size (e.g., N×N or H×W), according to a size of a dither matrix at work in the system. The parsed blocks may but need not coincide with mcblocks used by the coding/decoding processes, such as those represented by box 710. Within each parsed block, the method 700 may estimate the complexity of image data within the block and compare the complexity estimate to a predetermined threshold (box 740). The block's complexity may be obtained, for example, by estimating spatial variation within the parsed block. If the method 700 has access to coded video data corresponding to the region of the block, the complexity estimates may be derived from frequency coefficients therein (e.g., discrete cosine transform coefficients or wavelet transform coefficients) and a comparison of the energy of higher frequency coefficients to energy of lower frequency coefficients. If the block complexity exceeds the threshold, the method may advance to the next block without applying dither. If not, then the method may apply dithering as described above with respect to FIG. 10 or 11. The example of FIG. 16 illustrates the method computing a sum of the fractional component of each pixel value F(i,j) to a co-located value in the dither matrix (D(i,j)) (box 750) and incrementing the pixel integer component I(i,j) based on the sum (boxes 760, 770). Alternatively, the comparison technique of FIG. 11 may be used.

As compared to the embodiment of FIG. 10 or 11, the embodiment of FIG. 16 avoids injection of dither noise into regions of a picture that have high levels of detail.

In another embodiment, the operations of FIGS. 15 and 16 may be performed on a regional basis rather than on a pixel block basis. For example, the method may classify spatial areas of the frame into different regions based on complexity analyses, luminance analyses and/or edge detection algorithms. These regions need not coincide with the boundaries of pixel blocks obtained from coded data. Moreover, the detected regions may be irregularly shaped; they need not have square or rectangular boundaries. Having identified such regions, the method may assemble a dither overlay from one or more of the ordered dither matrix patterns discussed herein and apply ordered dither to the region to the exclusion of other regions that exhibit different complexity, luminance and/or edge characteristics.

As discussed above, the principles of the present invention find application in systems in which pixel data is represented as separate color components, for example, red-green-blue (RGB) components or luminance-chrominance components (Y, Cr, Cb). In such an embodiment, the methods discussed hereinabove may be applied to each of the component data independently. In some embodiments, it may be useful to provide different dither matrices for different color components. Where different dither matrices are provided, it further may be useful to provide matrices of different sizes (e.g., 16×16 for Y but 8×8 for Cr and Cb).

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 8 illustrates the components of the block-based coding chain 210 and prediction unit 220 as separate units, in one or more embodiments, some or all of them may be integrated and they need not be separate units. Such implementation details are immaterial to the operation of the present invention unless otherwise noted above.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. An image processing method, comprising:
parsing picture data into a plurality of blocks having a size corresponding to a dither matrix, the picture data comprising a plurality of pixels each having an integer component and a fractional component,
processing, on a pixel-by-pixel basis, the fractional component of each pixel value with respect to a corresponding dither value from the dither matrix,
incrementing the integer components of selected pixels based on the processing of the respective fractional component, and
storing the incremented integer components of the selected pixels and unchanged integer components of non-selected pixels for use as picture data.

2. The method of claim 1, wherein the integer data of a pixel is incremented if a sum of the fractional component of the pixel and the corresponding dither value exceeds 1.

3. The method of claim 1, wherein the integer data of a pixel is incremented if a sum of the fractional component of the pixel and the corresponding dither value is less than 1.

4. The method of claim 1, wherein the integer data of a pixel is incremented if the fractional component exceeds the corresponding dither value but is unchanged if not.

5. The method of claim 1, wherein the integer data of a pixel is incremented if the fractional component is less than the corresponding dither value but is unchanged if not.

6. The method of claim 1, wherein the processing, incrementing and storing are performed for every block of the picture.

7. The method of claim 1, wherein the processing, incrementing and storing are performed only for regions of the picture that have luminance values below a predetermined threshold.

8. The method of claim 1, wherein the processing, incrementing and storing are performed only for regions of the picture that have complexity values below a predetermined threshold.

9. The method of claim 1, wherein the dither matrix is a square matrix.

10. The method of claim 8, wherein the dither matrix has values of the form (X−1)/N², where N represents a size of the matrix and X takes values from 1 to N².

11. The method of claim 1, wherein the dither matrix is a rectangular matrix.

12. The method of claim 11, wherein the dither matrix has values of the form (X−1)/(H*W), where H*W represents a size of the matrix and X takes values from 1 to H*W.

13. The method of claim 1, wherein the dither matrix has fractional values that are pseudo-randomly distributed.

14. The method of claim 1, wherein
the pixel data includes at least three color components, each having respective integer and fractional components, and
the processing, incrementing and storing are performed on each of the color components.

15. A video encoder, comprising:
a block-based coding unit to code input pixel block data according to motion compensation;
a prediction unit to generate reference pixel blocks for use in the motion compensation, the prediction unit comprising:
decoding units to invert coding operations of the block-based coding unit;
a reference picture cache for storage of reference pictures;
storage for a dither matrix; and
a deblocking filter to:
perform filtering on data output by the decoding units,
process fractional components of filtered pixel data with respect to values in the dither matrix, and
increment integer components of selected filtered pixel data based on the comparison.

16. The encoder of claim 15, wherein the integer data of a pixel is incremented if a sum of the fractional component of the pixel and the corresponding dither value exceeds 1.

17. The encoder of claim 15, wherein the integer data of a pixel is incremented if a sum of the fractional component of the pixel and the corresponding dither value is less than 1.

18. The encoder of claim 15, wherein the integer data of a pixel is incremented if the fractional component exceeds the corresponding dither value but is unchanged if not.

19. The encoder of claim 15, wherein the integer data of a pixel is incremented if the fractional component is less than the corresponding dither value but is unchanged if not.

20. The encoder of claim 15, wherein the deblocking filter performs the processing and incrementing for every block of the picture.

21. The encoder of claim 15, wherein the deblocking filter performs the processing and incrementing only for blocks of the picture that have luminance values below a predetermined threshold.

22. The encoder of claim 15, wherein the deblocking filter performs the processing and incrementing only for blocks of the picture that have complexity values below a predetermined threshold.

23. The encoder of claim 15, wherein the dither matrix is a square matrix.

24. The encoder of claim 23, wherein the dither matrix has values of the form (X−1)/N², where N represents a size of the matrix and X takes values from 1 to N².

25. The encoder of claim 15, wherein the dither matrix is a rectangular matrix.

26. The encoder of claim 25, wherein the dither matrix has values of the form (X−1)/(H*W), where H*W represents a size of the matrix and X takes values from 1 to H*W.

27. The encoder of claim 15, wherein the dither matrix has fractional values that are pseudo-randomly distributed.

28. A video decoder, comprising:
a block-based decoder to decode coded pixel blocks by motion compensated prediction,
a frame buffer to accumulate decoded pixel blocks as frames,
a filter unit to
perform deblocking filtering on decoded frame data,
process fractional components of filtered pixel data with respect to values in the dither matrix, and
increment integer components of selected filtered pixel data based on the comparison.

29. The decoder of claim 28, wherein the integer data of a pixel is incremented if a sum of the fractional component of the pixel and the corresponding dither value exceeds 1.

30. The decoder of claim 28, wherein the integer data of a pixel is incremented if a sum of the fractional component of the pixel and the corresponding dither value is less than 1.

31. The decoder of claim 28, wherein the integer data of a pixel is incremented if the fractional component exceeds the corresponding dither value but is unchanged if not.

32. The decoder of claim 28, wherein the integer data of a pixel is incremented if the fractional component is less than the corresponding dither value but is unchanged if not.

33. The decoder of claim 28, wherein the deblocking filter performs the processing and incrementing for every block of the picture.

34. The decoder of claim 28, wherein the deblocking filter performs the processing and incrementing only for blocks of the picture that have luminance values below a predetermined threshold.

35. The decoder of claim 28, wherein the deblocking filter performs the processing and incrementing only for blocks of the picture that have complexity values below a predetermined threshold.

36. The decoder of claim 28, wherein the dither matrix is a square matrix.

37. The encoder of claim 36, wherein the dither matrix has values of the form (X−1)/N², where N represents a size of the matrix and X takes values from 1 to N².

38. The decoder of claim 28, wherein the dither matrix is a rectangular matrix.

39. The encoder of claim 38, wherein the dither matrix has values of the form (X−1)/(H*W), where H*W represents a size of the matrix and X takes values from 1 to H*W.

40. The decoder of claim 28, wherein the dither matrix has fractional values that are pseudo-randomly distributed.

41. An image signal created according to the process of:
parsing source picture data into a plurality of blocks having a size corresponding to a dither matrix, the picture data comprising a plurality of pixels each having an integer component and a fractional component,
processing, on a pixel-by-pixel basis, the fractional component of each pixel value to a corresponding dither value from the dither matrix,
incrementing the integer components of selected pixels based on the comparison of the respective fractional component, and
generating the image signal from the incremented integer components of the selected pixels and unchanged integer components of non-selected pixels.

42. The signal of claim 41, wherein the image signal is output to a display device.

43. The signal of claim 41, wherein the image signal is output to a decoder.
